(19) United States
(12) Patent Application Publication
(10) Pub. No.: US 2016/0204457 A1
(43) Pub. Date: Jul. 14, 2016

(54) Method For Operating A Fuel Cell Stack

(71) Applicant: SIEMENS AKTIENGESELLSCHAFT, Muenchen (DE)

(72) Inventors: Torsten BRANDT, Forchheim (DE); Albert HAMMERSCHMIDT, Erlangen (DE)

(21) Appl. No.: 14/912,618

(22) PCT Filed: Aug. 6, 2014
(86) PCT No.: PCT/EP2014/066924

§ 371 Date: Feb. 18, 2016

(30) Foreign Application Priority Data
Aug. 20, 2013 (DE) 10 2013 216 464.5
Sep. 25, 2013 (EP) 13185966.2

(51) Int. Cl. H01M 8/04746; H01M 8/0444; H01M 8/04537; H01M 8/04089

(52) U.S. Cl. CPC H01M 8/04753; H01M 8/04097; H01M 8/04447; H01M 8/04455; H01M 8/04544; H01M 2008/1095

(57) ABSTRACT

A method for operating a fuel cell stack which includes a number of fuel cells and at least one gas circuit, where the fuel cells are supplied on the gas inlet side with oxygen and hydrogen as reaction gases, and where at least oxygen is circulated in the fuel cells via the gas circuit, so as to provide a fuel cell stack with a simple structure and reliable intergas removal.

### CROSS-REFERENCE TO RELATED APPLICATIONS

This is a U.S. national stage of application No. PCT/EP2014/066924 filed 06 Aug. 2014. Priority is claimed on German Application No. 10 2013 216 464.5 filed 20 Aug. 2013 and EP 13185966.2 25 Sep. 2013, the contents of which are incorporated herein by reference in their entirety.

### BACKGROUND OF THE INVENTION

1. Field of the Invention

The invention relates to a method for operating a fuel cell stack having a number of fuel cells, to which oxygen and hydrogen are each supplied as reaction gases in a circulation mode, where the reaction gases circulate in separate gas circuits, fresh reaction gases are introduced into the gas circuits via supply valves and reaction gases present therein are drawn off from the gas circuits via discharge valves.

2. Description of the Related Art

A method and corresponding system concept of this type are similarly known from US 2012/0308906 A1 or US 2012/0270127 A1. The aim of these known methods is to prevent a shortage of H2 when the fuel cell stack is shut down. To this end the supply of fresh reaction gases is shut down at the start of the shut-down procedure. If the cell voltage drops below a predefined threshold value, air is injected into the oxygen-side gas circuit via a booster, so that the cell voltage rises. If the cell voltage again drops below the threshold value, the air supply is shut down and the reaction gas hydrogen is drawn off from the hydrogen-side gas circuit. During the shut-down procedure the reaction gases circulate in the respective gas circuits.

WO 2010/056224 A1 and U.S. 2002/0182456 A1 each disclose a method for the shut-down mode of a fuel cell stack, which however is operated not with oxygen but with air.

U.S. 2008/0187788 A1 discloses a fuel cell stack with two separate gas circuits for hydrogen and oxygen, in which jet pumps ensure the circulation of the reaction gases in question and both are connected to a storage unit. The supply of the reaction gases into the respective gas circuits can be controlled as a function of pressures of the respective reaction gases measured at the inlets and outlets of the fuel cell stack. The discharge of the reaction gases from the respective gas circuits into the storage unit can take place as a function of the measured concentrations of reaction gases.

Bents, David J., et al.: “Closed-Cycle Hydrogen-Oxygen Regenerative Fuel Cell at the NASA Glenn Research Center—An Update”, NASA/TM-2008-215055, 2008, disclose a hydrogen-oxygen PEM (proton exchange membrane) fuel cell stack with two separate gas circuits for hydrogen and oxygen, in which pumps ensure the circulation of the reaction gases in question. The circulation rate is controllable.

U.S. 2011/0045368 A1 and Hoberecht Mark A., et al.: “Development Status of PEM Non-Flow-Through Fuel Cell System Technology for NASA Applications”, NASA/TM-2011-217107, November 2011, each disclose a fuel cell stack with just one gas circuit for oxygen, while the fuel, e.g. hydrogen, is supplied and removed directly.

U.S. 2012/0308906 A1 or U.S. 2012/0270127 A1 each disclose a method and corresponding system in which the aim of these known methods is to prevent a shortage of H₂ when the fuel cell stack is shut down. To this end, a supply of fresh reaction gases is shut down at the start of a shut-down procedure. If the cell voltage drops below a predefined threshold value, air is injected into the oxygen-side gas circuit via a booster, such that the cell voltage rises. If the cell voltage again drops below the threshold value, the air supply is shut down and the reaction gas hydrogen is drawn off from the hydrogen-side gas circuit. During the shut-down procedure, the reaction gases circulate in the respective gas circuits.

WO 2010/056224 A1 and U.S. 2002/0182456 A1 each disclose a method for the shut-down mode of a fuel cell stack, which however is operated not with oxygen but with air.

U.S. 2008/0187788 A1 discloses a fuel cell stack having two separate gas circuits for hydrogen and oxygen, where jet pumps ensure the circulation of a particular reaction gases and which are both connected to a storage unit. Here, the supply of the reaction gases into the respective gas circuits can be controlled as a function of pressures of the respective reaction gases measured at the inlets and outlets of the fuel cell stack. The discharge of the reaction gases from the respective gas circuits into the storage unit can occur as a function of measured concentrations of reaction gases.

Bents, David J., et al.: “Closed-Cycle Hydrogen-Oxygen Regenerative Fuel Cell at the NASA Glenn Research Center—An Update”, NASA/TM-2008-215055, 2008, disclose a hydrogen-oxygen proton exchange membrane (PEM) fuel cell stack with two separate gas circuits for hydrogen and oxygen, where pumps ensure the circulation of the particular reaction gases. The circulation rate is controllable.

U.S. 2011/0045368 A1 and Hoberecht Mark A., et al.: “Development Status of PEM Non-Flow-Through Fuel Cell System Technology for NASA Applications”, NASA/TM-2011-217107, November 2011, each disclose a fuel cell stack with just one gas circuit for oxygen, while the fuel, s hydrogen, is supplied and removed directly.

Hydrogen-oxygen proton exchange membrane (PEM) fuel cells are operated with both hydrogen and oxygen media as reactants. These reaction gases contain, depending on the degree of purity, inert or noble gases originating from the production process of between 1 and 0.001% vol. In fuel cell operation, these inert gas components accumulate in the reactant chambers and must be removed, so as to not impede the operation of the fuel cell. For this reason, the inert gases must be removed from the fuel cell continually or at intervals. In a well ventilated environment (e.g., in the open air), this is unproblematic on the oxygen side; on the hydrogen side it must be ensured, by suitably routing the gas, that no combustible gas mixtures can occur as a result of a residual anode gas. In a closed atmosphere (e.g., in a submarine), these quantities of residual gas must be reduced to a minimum. In addition, small quantities of residual gas also mean a high level of utilization of the reactants.

An inert gas compatibility of the hydrogen-oxygen fuel cells, low quantities of residual gas and high utilization of the reactants are achieved for example by a so-called cascading of the fuel cells. Such a cascading of the fuel cells is described, e.g., in EP 0 596 366 B1, WO 02/27849 A1 or EP 2 122 737 B1. This cascading represents a sequence of hydrogen-oxygen fuel cells with an increasing inert gas concentration per cascade, which ends in the last cascade, the “purging cells”. The voltage of these cells regulates the discharge of the purging cells and, thus, the voltage of the entire fuel cell stack. Lower quantities of residual gas can be achieved in this way, as is desirable, such as in a submarine.

As specified in WO 02/27849, the solution described above means however a relatively complex structure of the fuel cell stack with different components at the cell level for implementation of the internal cascading and an associated complex process and control technology (e.g., separators or valves).

### SUMMARY OF THE INVENTION

In view of the foregoing, it is an object of the invention provide a method for enabling, in the case of a fuel cell stack to which oxygen and hydrogen circulating in separate gas circuits are supplied, a reliable discharge of inert gas combined with a high utilization level of the quantities of gas.

This and other objects and advantages are achieved in accordance with the invention by implementing a method in which the circulation rate is increased as the gas concentration of a respective reaction gas decreases, where starting with a gas concentration of, depending on the degree of purity, up to 100% of the respective reaction gas, the circulation rate is increased independently for each of the two gas circuits in the circulation mode, and upon achieving a minimum concentration of the respective reaction gas some of the reaction gas is discharged in the gas circuit and is replaced by fresh air.

Both reaction gases (oxygen and hydrogen) are supplied to the fuel cell stack in the circulation mode, for which purpose two separate gas circuits are provided, and the circulation mode on the oxygen side and on the hydrogen side are preferably controlled or regulated independently of one another.

In this case, a change in the operating parameters of the circulation mode in the gas circuit starts in particular at a concentration of 3% vol. of inert gas in the hydrogen flow and of 15% vol. of inert gas in the oxygen flow.

In response to a rise in the percentage of inert gas in the gas circuit, the circulation rate (volume flow) of the reaction gas present in the gas circuit increased. Thus a high utilization level of the quantities of gas is achieved. If this measure is insufficient, i.e., if the percentage of inert gas continues to rise, some of the reaction gas is discharged and replaced by fresh gas.

The circulation mode of a hydrogen-oxygen PEM fuel cell stack thus starts in particular with a gas concentration of respectively 100% of the respective reaction gas and rapidly decreases initially; in continuous operation (steady state) the maximum percentage of inert gas is typically around 40% for oxygen and around 5% for hydrogen. Here, the inert gas compatibility (i.e. the consistency of voltage or performance) of the hydrogen-oxygen PEM fuel cell is achieved by increasing the circulation when the percentage of inert gas rises or the cell voltage falls and for a corresponding quantity of inert gas or when the cell voltage is undershot by partially discharging the gas chambers for oxygen and hydrogen independently of one another and accordingly adding new reactants.

The percentage of hydrogen or oxygen in the respective reactant chambers is preferably determined in parallel using suitable sensors. Alternatively, the concentration of one of the residual gases, in particular of the hydrogen, is detected and the circulation speed and the purging, in particular of the oxygen circuit, are regulated via the cell voltage.

The circulation rate (i.e., the volume flow or throughput of reaction gas in the gas circuit) is preferably determined by a pressure loss measurement, such as via the compressor or the fuel cell. Using the pressure loss, the flow speed or the volume flow (a minimum volume flow should not be undershot) of the reaction gases is determined.

An increase in the pressure in the fuel cells or in the fuel cell stack is particularly achieved by arranging a supply valve between the outlet of the fuel cell stack and the compressor (or a circulation pump).

Here, the discharge valve for discharge of the residual gas is expediently executed as a 3-way valve. Accordingly, the reactant containing inert gas is drawn off from the fuel cell outlet during a discharge operation and the fuel cell inlet is in parallel supplied with fresh reactant via the supply valve, where mixing of the reaction gas containing inert gas with the fresh gas is avoided.

The circulation mode is in particular applied to several fuel cells supplied in parallel.

The maximal percentages of inert gas occurring are reduced in particular during secondary treatment of the residual gases in a hydrogen recombiner (or another fuel cell), as known from the above-cited U.S. 2008/0187788 A1.

The above-described operating mode is especially advantageous if small fuel cell units or modules (up to approx. 50 kW) are operated in an interconnected manner, because here the alternative cascaded principle cannot be applied, or only at significant expense, especially for reasons of space or cost.

The percentage of inert gas depends on the gas qualities and purging characteristics. Typically, the maximum percentage of inert gas is around 40% for oxygen, and thus easily undershoots the percentage of inert gas of air-operated PEM fuel cells, along with significantly higher levels of efficiency.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are explained in greater detail on the basis of a drawing, in which:

FIG. 1 shows a circulation mode of the reaction gases of a fuel cell stack without recombination;

FIG. 2 shows a circulation mode of the reaction gases of a fuel cell stack with recombination; and

FIG. 3 is a flowchart of the method in accordance with the invention.

### DETAILED DESCRIPTION OF THE EXEMPLARY EMBODIMENTS

The same reference characters have the same meaning in the various figures.

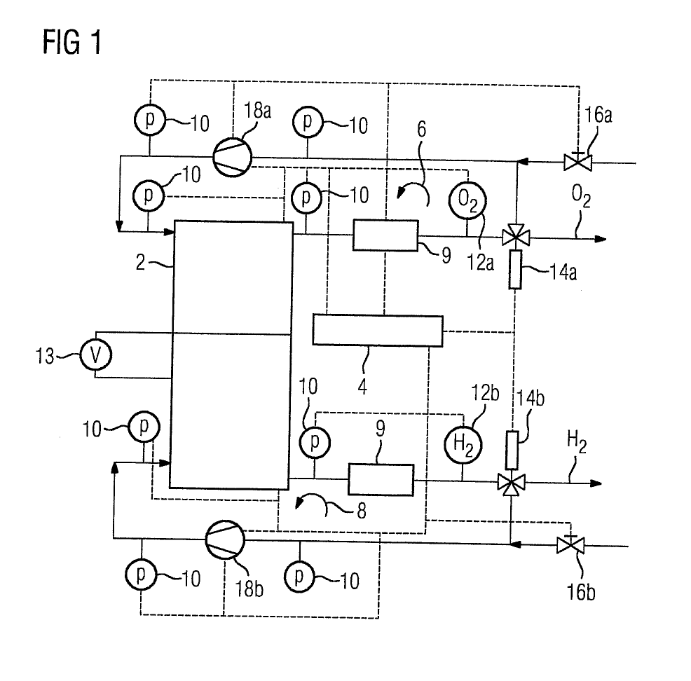

FIG. 1 shows a fuel cell stack 2 comprising a plurality (not shown here in greater detail) of fuel cells with an associated controller 4. On the gas inlet side of the fuel cell stack 2, oxygen O₂ and hydrogen H₂ are supplied. A gas circuit 6, 8 is provided for the respective reaction gas, so that the reaction gases oxygen and hydrogen are supplied in a circulation mode into the fuel cell stack 2. Gas separators are designated by the reference character 9 in both figures.

Integrated into each gas circuit 6, 8 are pressure gauges and concentration measurement devices 12a, 12b for measuring a concentration of the reaction gases. The measurement signals are fed to the controller 4 and, based on these measurement signals, a 3-way valve 14a, 14b is actuated. Additionally provided is a voltmeter 13 for measuring a voltage drop in the operation of the fuel cells.

Both gas circuits 6, 8 are controlled independently of one another. When a minimum concentration of oxygen or hydrogen is reached in the respective gas circuit 6, 8, the reaction gas present is at least partially discharged and replaced by fresh gas through a valve 16a, 16b.

Additionally integrated into each gas circuit 6, 8 is a circulation pump or a compressor 18a, 18b for feeding the respective reaction gas into the fuel cell stack 2.

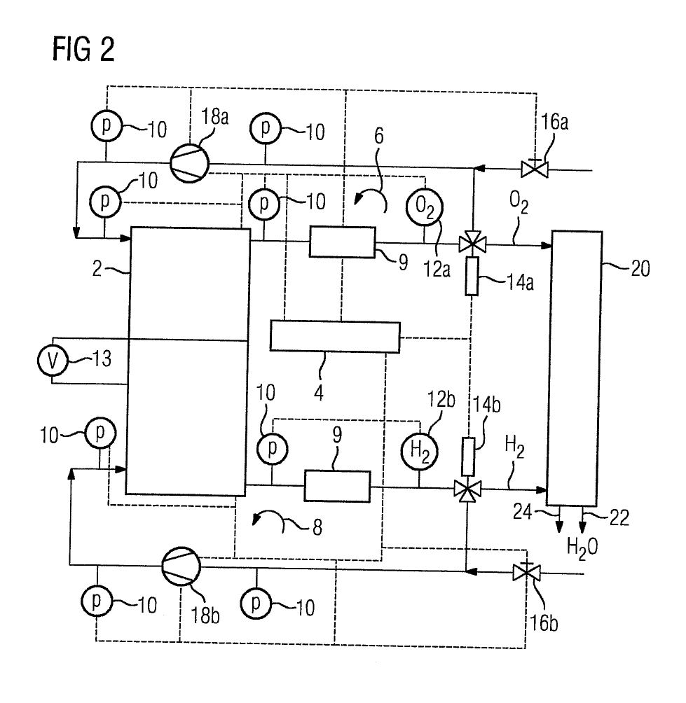

FIG. 2 differs from FIG. 1 merely in that the flow of hydrogen and oxygen downstream of the fuel cell stack 2 is supplied to a hydrogen recombiner 20, from which a flow of water 22 and a flow of inert gas 24 are drawn off. In place of the recombiner 20, another downstream consumer unit, such as a further fuel cell or a further fuel cell stack, can be provided, in which the oxygen and the hydrogen react.

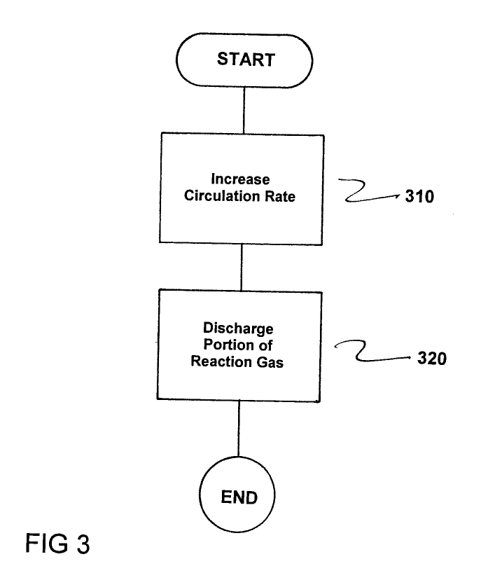

FIG. 3 is a flowchart of a method for operating a fuel cell stack (2) comprising a number of fuel cells, to which an oxygen flow and hydrogen flow are each supplied as reaction gases in a circulation mode, where reaction gases circulate in separate gas circuits (6, 8), fresh reaction gases are introduced into the gas circuits (6, 8) via supply valves (16a, 16b) and reaction gases present therein are drawn off from the separate gas circuits (6, 8) via discharge valves (14a, 14b).

The method comprises increasing the circulation rate as a gas concentration of gas of a respective reaction gas decreases, starting with a gas concentration of, depending on a degree of purity, up to 100% of the respective reaction gas, as indicated in step 310. Here, the circulation rate is increased independently for each of the separate gas circuits (6, 8) in a circulation mode. Next, a portion of the reaction gas in the gas circuit is then discharged and the discharged portion of the reaction gas is replaced by fresh reaction gas upon achieving a minimum concentration of the respective reaction gas, as indicated in step 320.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A method for operating a fuel cell stack comprising a number of fuel cells, to which an oxygen flow and hydrogen flow are each supplied as reaction gases in a circulation mode, wherein reaction gases circulate in separate gas circuits, fresh reaction gases are introduced into the gas circuits via supply valves and reaction gases present therein are drawn off from the separate gas circuits via discharge valves, the method comprising:
increasing the circulation rate as a gas concentration of gas of a respective reaction gas decreases, starting with a gas concentration of, depending on a degree of purity, up to 100% of the respective reaction gas, said circulation rate being increased independently for each of the separate gas circuits in a circulation mode; and
discharging a portion of the reaction gas in the gas circuit and replacing the discharged portion of the reaction gas by fresh reaction gas upon achieving a minimum concentration of the respective reaction gas.

17. The method as claimed in claim 16, wherein the increase in the circulation rate starts at a concentration of 3% volume of inert gas in the hydrogen flow and 15% volume of inert gas in the oxygen flow.

18. The method as claimed in claim 16, wherein the discharge of the portion of the reaction gas and replacement of the reaction gas by the fresh reaction gas occurs at a concentration of 5% volume of inert gas in the hydrogen flow and of 40% volume of inert gas in the oxygen flow.

19. The method as claimed in claim 17, wherein the discharge of the portion of the reaction gas and replacement of the reaction gas by the fresh reaction gas occurs at a concentration of 5% volume of inert gas in the hydrogen flow and of 40% volume of inert gas in the oxygen flow.

20. The method as claimed in claim 16, wherein the gas concentration of the reaction gas within the each separate gas circuits is measured, and based on a change in concentration at least one of (i) the circulation rate is controlled or regulated and (ii) the discharge and replacement of the reaction gas in the respective circuit is controlled or regulated.

21. The method as claimed in claim 17, wherein the gas concentration of the reaction gas within the each separate gas circuits is measured, and based on a change in concentration at least one of (i) the circulation rate is controlled or regulated and (ii) the discharge and replacement of the reaction gas in the respective circuit is controlled or regulated.

22. The method as claimed in claim 18, wherein the gas concentration of the reaction gas within the each separate gas circuits is measured, and based on a change in concentration at least one of (i) the circulation rate is controlled or regulated and (ii) the discharge and replacement of the reaction gas in the respective circuit is controlled or regulated.

23. The method as claimed in claim 16, wherein the gas concentration of the reaction gas of the separate gas circuits is measured and based a change in concentration at least one of (i) the circulation rate is controlled or regulated and (ii) the discharge and replacement of the reaction gas in the respective gas circuit is controlled or regulated; and
wherein the cell voltage of the fuel cells is measured and based on the circulation rate at least one of (i) a change in the cell voltage is controlled or regulated and (ii) the discharge and replacement of the reaction gas in another of the separate gas circuits is controlled or regulated.

24. The method as claimed in claim 17, wherein the gas concentration of the reaction gas of the separate gas circuits is measured and based a change in concentration at least one of (i) the circulation rate is controlled or regulated and (ii) the discharge and replacement of the reaction gas in the respective gas circuit is controlled or regulated; and
wherein the cell voltage of the fuel cells is measured and based on the circulation rate at least one of (i) a change in the cell voltage is controlled or regulated and (ii) the discharge and replacement of the reaction gas in another of the separate gas circuits is controlled or regulated.

25. The method as claimed in claim 18, wherein the gas concentration of the reaction gas of the separate gas circuits is measured and based a change in concentration at least one of (i) the circulation rate is controlled or regulated and (ii) the discharge and replacement of the reaction gas in the respective gas circuit is controlled or regulated; and
wherein the cell voltage of the fuel cells is measured and based on the circulation rate at least one of (i) a change in the cell voltage is controlled or regulated and (ii) the discharge and replacement of the reaction gas in another of the separate gas circuits is controlled or regulated.

26. The method as claimed in claim 23, wherein the other gas circuit of the separate gas circuits is a gas circuit on the hydrogen flow side and the other gas circuit is the gas circuit on the oxygen flow side.

27. The method as claimed in claim 16, wherein the method is implemented in its use in a proton exchange membrane fuel cell system having at least one fuel cell stack.
